(19) United States
(12) Patent Application Publication
(10) Pub. No.: US 2026/0197156 A1
(43) Pub. Date: Jul. 9, 2026

(54) Dynamic cache creation for operating cloud containers

(71) Applicant: Bank of America Corporation, Charlotte, NC (US)

(72) Inventors: Shiva Chinthakindi, McKinney, TX (US); Vinod Maghnani, Gurugram (IN); Sneha Vidyasagar Yadav, Mumbai (IN); Deepak Kalra, New Delhi (IN)

(21) Appl. No.: 19/010,613

(22) Filed: Jan. 6, 2025

(51) Int. Cl. H04L 9/08; H04L 9/06; H04L 67/10

(52) U.S. Cl. CPC H04L 9/0825; H04L 9/0643; H04L 9/0894; H04L 67/10

(57) ABSTRACT

A system includes a memory operable to store user data and a processor operably coupled to the memory. The processor is configured to access a set of user data, generate hashed data of the set of user data, and generates a digital key by encrypting the hashed data. The processor is further configured to store the digital key in a first container operating on a first node in a distributed cloud computing system. The processor is further configured to generate a cache to store the digital key. Each node in the distributed cloud computing system maintains a copy of the cache. The processor is further configured to detect a trigger event, retrieve the first digital key from the copy of the cache associated with a second node, and store the first digital key in a second container executing on the second node.

### TECHNICAL FIELD

The present disclosure relates generally to operating cloud containers, and more specifically, to dynamic cache creation for operating cloud containers.

### BACKGROUND

A distributed cloud environment is a cloud computing architecture that uses multiple public clouds in different locations, while a single cloud service provider manages the operations, governance, and updates.

### SUMMARY

Conventional technical management of container data in distributed cloud environment is often centralized, which can lead to a single point of failure and potential security vulnerabilities. Additionally, existing systems may be unable to handle real-time updates to user data details, leading to potential delays and inaccuracies in user verification.

The system disclosed in the present application provides a technical solution to the problems discussed above. The disclosed system can manage user data stored in containers in a distributed cloud computing environment. The disclosed system uses encryption and digital signatures to create a digital key comprising user data. The digital key is stored in a container, which is then distributed across the cloud computing environment. To enable efficient access of the digital key in a container, the disclosed system generates cache to store the digital key. The disclosed system updates the cache in real time so that the cache would store the most recent data in the container. The cache would be implemented using a distributed key-value database, which would be deployed on the nodes of the cloud computing environment. Each of the nodes would maintain a copy of the cache, which would be synchronized in real-time using a consensus algorithm.

In one embodiment, the disclosed system includes a memory operable to store user data. The disclosed system also includes a processor operably coupled to the memory. The processor is configured to access a first set of the user data from the memory. The processor is then configured to generate, by a hashing algorithm, hashed data of the first set of the user data. The processor is then configured to generate a first digital key by encrypting the hashed data using a digital signature. The processor is then configured to store the first digital key in a first container operating on a first node of a plurality of nodes in a distributed cloud computing system. The processor is then configured to generate a cache using a distributed key-value database to store the first digital key. Each of the plurality of nodes in the distributed cloud computing system maintains a copy of the cache. The first digital key is accessible from a respective copy of the cache associated with each of the plurality of nodes. The processor is then configured to detect a trigger event associated with the first node. The trigger event includes one or more of a failure of the first node, a degraded performance of the first node, or a data transmission issue associated with the first node. The processor is then configured to, responsive to the detection of the trigger event, retrieve the first digital key from the copy of the cache associated with a second node of the plurality of nodes. The processor is further configured to store the first digital key in a second container executing on the second node.

In one embodiment, the processor of the disclosed system is further configured to receive a request from a user device via the distributed cloud computing system to access the first set of the user data. The processor is then configured to identify a third node having a minimal distance to the user device among the plurality of nodes. The processor is then configured to retrieve the first digital key from the copy of cache on the third node. The processor is then configured to decrypt the first digital key to generate the first set of the user data. The processor is further configured to transmit the first set of the user data to the user device via the third node.

In one embodiment, the processor of the disclosed system is further configured to identify the first set of the user data based on determining that the first set of the user data requires access at a frequency higher than a threshold frequency.

In one embodiment, the processor of the disclosed system is further configured to execute a consensus algorithm on the plurality of nodes. The processor is also configured to select the second container based on an execution result of the consensus algorithm. The execution result indicates the second container is associated with a required data accuracy or a required security level.

In one embodiment, the processor of the disclosed system is further configured to detect a third container added to the distributed cloud computing system, wherein the third container comprises a second digital key corresponding to a second set of the user data. The processor is then configured to update the cache to store the second digital key. Each of the plurality of nodes in the distributed cloud computing system maintains a copy of the updated cache. The second digital key is accessible from the respective copy of the updated cache associated with each of the plurality of nodes.

In one embodiment, the processor of the disclosed system is further configured to detect an update to the first set of the user data. The processor is then configured to generate an updated first digital key comprising the update to the first set of the user data. The processor is then configured to store the updated first digital key in the second container. The processor is further configured to update the cache to store the updated first digital key. Each of the plurality of nodes in the distributed cloud computing system maintains a copy of the updated cache. The updated first digital key is accessible from the respective copy of the updated cache associated with each of the plurality of nodes.

In one embodiment, the processor of the disclosed system is further configured to categorize the first set of the user data into a plurality of categories. The processor is then configured to determine a plurality of portions of the first digital key corresponding to the plurality of categories of the first set of the user data. The processor is then configured to store the plurality of portions of the first digital key in a plurality of parts of the first container.

In one embodiment, the processor is further configured to generate a plurality of blocks in the cache to store the plurality of portions of the first digital key, respectively.

In one embodiment, the processor of the disclosed system is further configured to receive a request from a user device to access a second set of the user data. The processor is then configured to determine a second digital key corresponding to the second set of the user data does not exist in the cache. The processor is then configured to access the second set of the user data from the memory. The processor is then configured to generate, by the hashing algorithm, hashed data of the second set of the user data. The processor is then configured to generate the second digital key by encrypting the hashed data using the digital signature. The processor is then configured to store the second digital key in the cache. The processor is then configured to identity a third node having a minimal distance to the user device among the plurality of nodes. The processor is then configured to retrieve the second digital key from the copy of cache on the third node. The processor is then configured to decrypt the second digital key to generate the second set of the user data. The processor is further configured to transmit the second set of the user data to the user device via the third node.

In one embodiment, the processor of the disclosed system is further configured to generate a request for the cache based on the first digital key. The processor is then configured to determine the request is a valid request by comparing the request with a collection of valid request. The processor is further configured to generate the cache responsive to determining the request is a valid request.

The disclosed system and methods provide the practical application of securely and efficiently operating containers in a distributed cloud computing system. Conventional container operation in a distributed cloud system is often centralized, which can lead to a single point of failure and potential security vulnerabilities. Additionally, conventional container operation is unable to handle real-time updates to user data in containers, leading to potential delays and inaccuracies in operations based on user data. The disclosed system and methods can address such problems by using a dynamic caching technology to update encrypted user data in containers in real time. As described in example embodiments of the present disclosure, the disclosed system and methods create a digital key for user data using hashing algorithms and digital signatures, which can enhance the security and integrity of user data. The disclosed system and methods then use a cache in the cloud computing system to store the digital key. The cache would be deployed on a network of nodes in the cloud computing system. In case a node fails or has other issues, another node can take over the digital key and store it in its container for operation, thereby improving the robustness and security of container operation in the cloud computing system. Whenever a container is created or updated, the disclosed system and methods can trigger the cache to update its content in real time so that the cache would store the most recent digital key, thereby preventing delays and improving accuracies in operations based on user data.

Technical advantages of certain embodiments of this disclosure may include one or more of the following. By encrypting user data into digital keys using hashing algorithms and digital signatures, the disclosed system and methods can ensure that the operation of user data remains secure. For example, hashing algorithms and digital signatures can safeguard the user data against potential malicious attacks. By using a content delivery network operating on the cloud computing system, the disclosed system and methods can ensure that the digital keys exchanged between containers cannot be intercepted or tampered with without detection. By using a consensus algorithm on the content delivery network, the disclosed system and methods can enhance the security and efficiency of container identification processes while managing digital keys securely. For example, the consensus algorithm can determine which container is the most secure and valid container so that the digital key can be transmitted to the most secure and valid container if another container storing the digital key is failing. By using real-time dynamic cache updating technology, the disclosed system and methods can ensure fast and efficient access to the most recent user data. For example, whenever a container is created or updated, the disclosed system and methods can trigger the cache to update its content in real time so that the cache would store the most recent digital key.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of an architecture that is configured for using dynamic cache for operating cloud containers.

FIG. 2 illustrates one embodiment of an operational flow for updating a dynamic cache.

FIG. 3 illustrates one embodiment of an operational flow for creating a dynamic cache.

FIGS. 4A-4C illustrate an example flowchart of a method for using dynamic cache for operating cloud containers.

### DETAILED DESCRIPTION

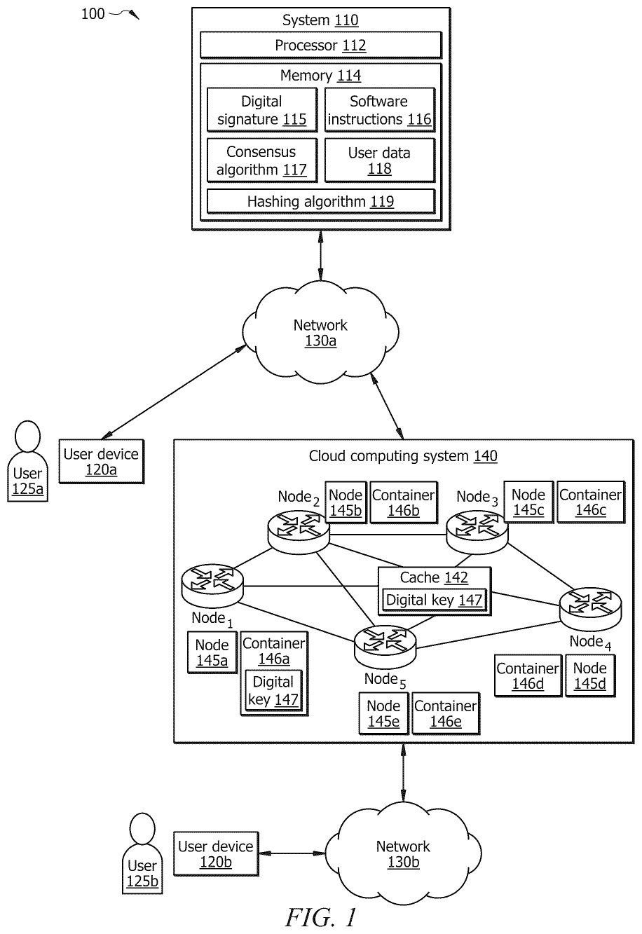

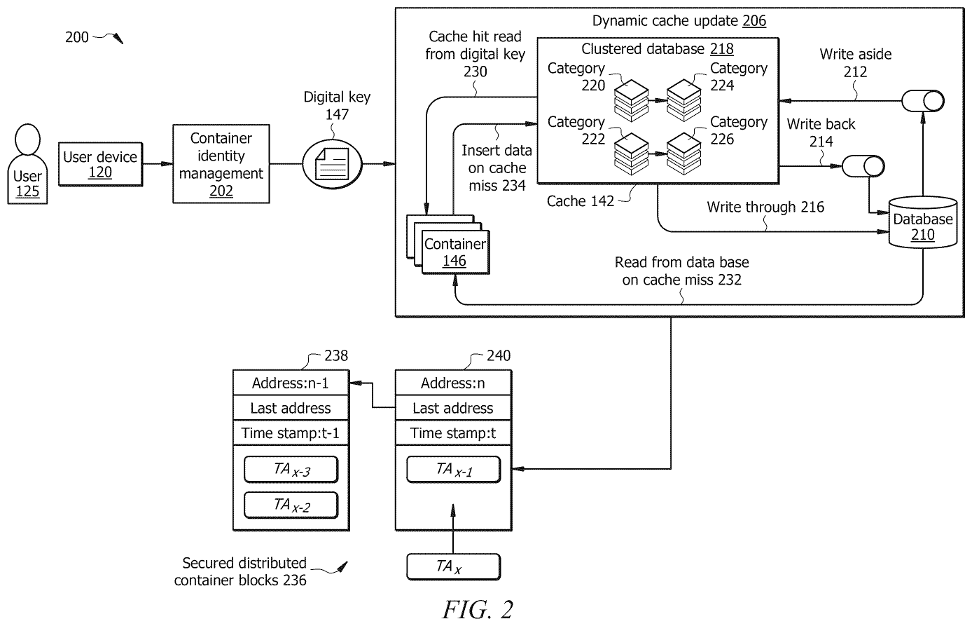

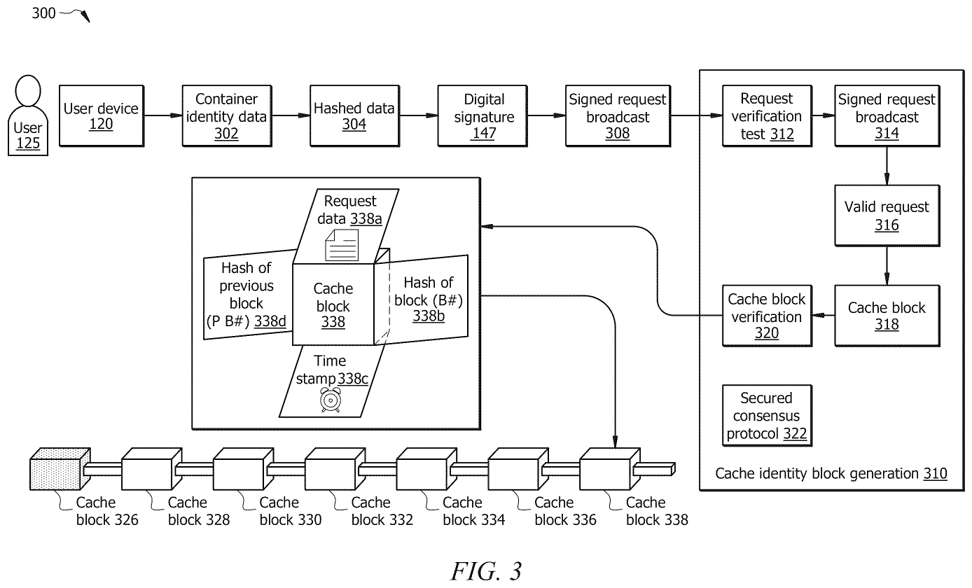

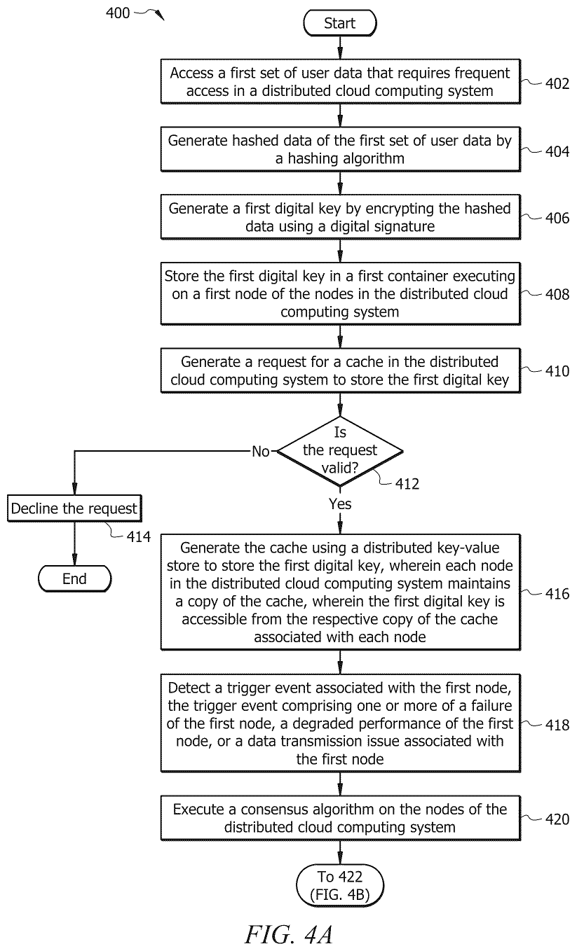

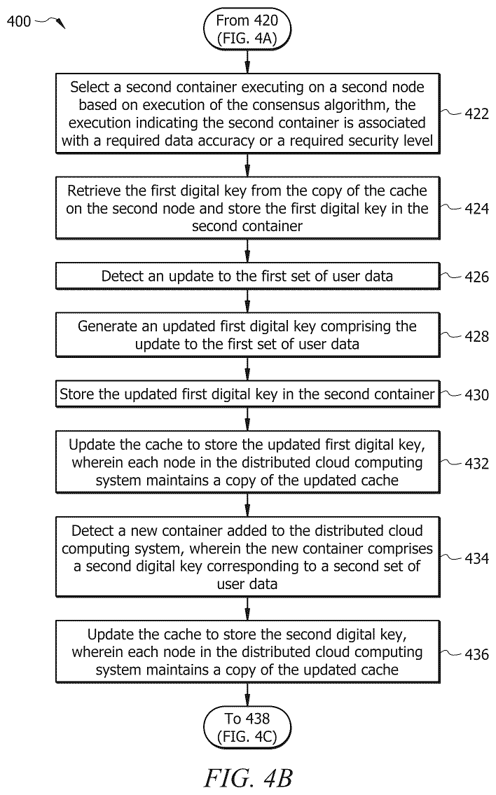

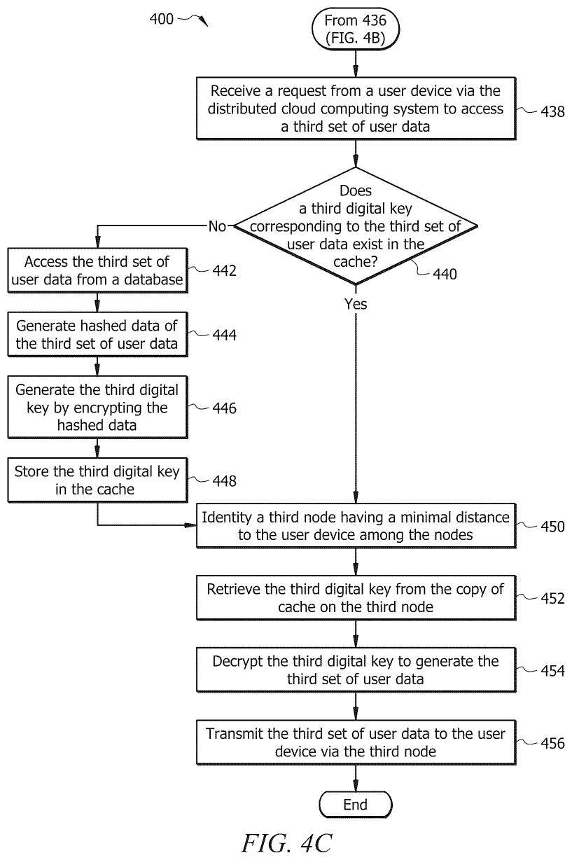

As described above, conventional technical management of container data in distributed cloud environment is often centralized and unable to handle real-time updates. This disclosure provides various systems and methods to manage user data stored in containers in a distributed cloud computing environment securely and efficiently. FIG. 1 illustrates one embodiment of an architecture that is configured for generating dynamic cache for operating cloud containers. FIG. 2 illustrates one embodiment of an operational flow for updating a dynamic cache. FIG. 3 illustrates one embodiment of an operational flow for creating a dynamic cache. FIGS. 4A-4B illustrate an example flowchart of a method for using dynamic cache for operating cloud containers.

### Example System for Using Dynamic Cache for Operating Cloud Containers

FIG. 1 illustrates one embodiment of an architecture 100 that is configured for using dynamic cache for operating cloud containers. Architecture 100 comprises a system 110, a user device 120a associated with user 125a, a user device 120b associated with user 125b, a network 130a, a network 130b, and a cloud computing system 140. In some embodiments, architecture 100 may not have all of the components listed and/or may have other elements instead of, or in addition to, those listed above.

### Architecture Components

### System

System 110 is generally any device that is configured to process data and communicate with devices (e.g., user device 120a), systems (e.g., cloud computing system 140), etc. System 110 is generally configured to perform operations described further below in conjunction with method 400 described in FIGS. 4A-4B. In one embodiment, system 110 comprises processors 112 in signal communication with a memory 114.

Processors 112 comprise one or more processors operably coupled to the memory 114. Processors 112 are any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). Processors 112 may be a programmable logic device, a microcontroller, a microprocessor, or any suitable combination of the preceding. Processors 112 are communicatively coupled to and in signal communication with memory 114. Processors 112 are configured to process data. For example, processors 112 may be 8-bit, 16-bit, 32-bit, 64-bit or of any other suitable architecture. Processors 112 may include an arithmetic logic unit (ALU) for performing arithmetic and logic operations, processors register that supply operands to the ALU and store the results of ALU operations, and a control unit that fetches software instructions 116 from memory 114 and executes them by directing the coordinated operations of the ALU, registers and other components. Processors 112 are configured to implement various software instructions 116. For example, processors 112 are configured to execute software instructions 116 to implement the functions disclosed herein, such as some or all of those described with respect to FIGS. 1-4. In some embodiments, the function described herein is implemented using logic units, FPGAs, ASICs, DSPs, or any other suitable hardware or electronic circuitry.

Memory 114 may be volatile or non-volatile and may comprise a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. Memory 114 is operable to store the software (e.g., consensus algorithm 117 and hashing algorithm 119), and/or any other data (e.g., user data 118 and digital signature 115) or software instructions 116. In one embodiment, user data 118 can be any type of data that comprises identity information associated with users. The software instructions 116 may comprise any suitable set of instructions, logic, rules, or code operable to execute the processors 112. The software instructions 116, when executed by the processors 112, cause the processors 112 to perform one or more functions described herein. For example, when the software instructions 116 are executed, the processors 112 execute the software instructions 116 to use hashing algorithm 119 and digital signature 115 to create a digital key 147 comprising user data 118 and instruct the cloud computing system 140 to store the digital key 147 in a container 146 (e.g., container 146a). When the software instructions 116 are executed, the processors 112 further execute the software instructions 116 to generate cache 142 to store the digital key 147 and update the cache 142 in real time so that the cache 142 would store the most recent data in the container 146.

### User Device

Examples of user device 120 include, but are not limited to, computers, laptops, mobile devices (e.g., smart phones or tablets), servers, clients, or any other suitable type of device associated with user 125. User device 120 is generally configured to capture data and send instructions for processing the data to system 110 and/or cloud computing system 140. For example, the instructions from user device 120a to system 110 may comprise a request for container identity management. As another example, the data to user device 120b from cloud computing system 140 may comprise user data 118. In other examples, the data may comprise any suitable type of data. The instructions may comprise any suitable type or number of commands for processing the data.

### Network

Network 130 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 130 may be configured to support any suitable type of communication protocol as would be appreciated by one of ordinary skill in the art.

### Cloud Computing System

Cloud computing system 140 may offers network services (e.g., network applications) over a network 130b to user devices 120b. Examples of the network services may include an infrastructure-as-a-service (IaaS), a platform-as-a-service (PaaS), a software-as-a-service (SaaS), and managed services. Cloud computing system 140 may comprise a plurality of nodes 145. The plurality of nodes 145 may be used to host the network service provided by the cloud computing system 140. These nodes 145 may store and manage data, run applications, and deliver content and services like streaming videos, web mail, and office productivity software over the network 130b. Each node 145 may be a computer, virtual machine (VM), or container that works with other nodes 145 and may be configured to perform any of the functions or actions of the cloud computing system 140 described herein. In one embodiment, a respective container 146 may operate on each node 145.

In one embodiment, a content delivery network (CDN) may operate based on the cloud computing system 140 to deliver content to user devices 120 more quickly and reliably by using cache 142. CDN may distribute user requests and deliver data from nodes 145 that are geographically close to requesting user devices 120b. For example, when user device 120b requests data, node 145e may be geographically close to user device 120b. Accordingly, CDN may access the requested data (e.g., digital key 147) from cache 142 and deliver the requested data to user device 120b via node 145e.

### Operational Flow

User 125 may use user device 120 to request secured management of user data 118 via containers 146 in the cloud computing system 140. System 110 may generate a digital key 147 for user data 118 by encrypting user data 118 using the hashing algorithm 119 and digital signature 115. System 110 may then store the digital key 147 in container 146a operating on node 145a of the cloud computing system 140.

System 110 may generate a cache 142 using a distributed key-value database to store the digital key 147. Cache 142 is a temporary virtual storage. Cache 142 can enable a user device 120b to quicky access the digital key 147 via a content delivery network operating on the cloud computing system 140. In an embodiment, each node 145 in the cloud computing system 140 may maintain a copy of the cache 142. The digital key 147 is accessible from a respective copy of the cache 142 associated with each node 145.

User device 120b can request to access the digital key 147 via the cloud computing system 140. In an embodiment, system 110 may identify a node 145 that has the minimal distance to user device 120b among all the nodes 145. For example, if user device 120b is in California, USA, a node 145 in USA instead of a node 145 in Europe may be identified. System 110 may then retrieve the digital key 147 from the copy of cache 142 on the identified node 145. In an embodiment, system 110 may decrypt the digital key 147 to generate the corresponding user data 118 and transmit the user data 118 to user device 120b via the identified node 145.

In an embodiment, the user data 118 corresponding to the digital key 147 may be updated. Upon detecting such update, system 110 may generate an updated digital key 147 including the update to the user data 118. In an embodiment, digital key 147 may be configured to emit an event that would trigger cache 142 to update its content. System 110 may then store the updated digital key 147 in container 146a. System 110 may further update the cache 142 to store the updated digital key 147.

In an embodiment, a trigger event may occur on node 145a which has the digital key 147 contained in its container 146a. For example, the trigger event may be a failure of node 145a, a degraded performance of node 145a, or a data transmission issue associated with node 145a. Upon detecting the trigger event, system 110 may execute consensus algorithm 117 on the nodes 145 of the cloud computing system 140 to determine which container 146 is the most secured and valid container 146 that could replace container 146a. Upon identifying the correct container 146 to replace container 146a, system 110 may retrieve the digital key 147 from the copy of the cache 142 associated with the node 145 where the identified container 146 operates and store the digital key 147 in that container 146. As an example, and not by way of limitation, system 110 may have container 146d replace container 146a and store the digital key 147 in container 146d.

In an embodiment, a new container 146 could be added to the cloud computing system 140. The newly added container 146 may contain a new digital key 147 corresponding to another set of user data 118. Upon detecting the new container 146, system 110 may update the cache 142 to store the new digital key 147. Each node 145 in the cloud computing system 140 may maintain a copy of the updated cache 142. The new digital key 147 is accessible from the respective copy of the updated cache 142 associated with each node 145.

### Dynamic Cache Update

FIG. 2 illustrates one embodiment of an operational flow 200 for using a dynamic cache to operate cloud containers.

In one embodiment, user 125 may use user device 120 to access container identity management 202 executed by system 110. System 110 may generate one or more digital keys 147 for user data 118 transmitted from user device 120 or for user data 118 updated by user device 120.

System 110 may then perform dynamic cache update 206. In one embodiment, system 110 may generate a cache 142 for a content delivery network operating on a cloud computing system 140. Cache 142 may store digital keys 147 that require frequent access. In an embodiment, frequent access may indicate that a digital key 147 is accessed at a frequency higher than a threshold frequency. For example, the threshold frequency may be once per day and any digital key 147 is accessed at a frequency higher than once per day (e.g., once per hour) may be stored in cache 142. A plurality of caching techniques can be used for storing digital keys 147 in cache 142. In one embodiment, when a digital key 147 requiring frequent access is written to database 210, the digital key 147 may be pushed to cache 142 using write aside caching 212. In another embodiment, using write back caching 214, a digital key 147 requiring frequent access may be written in cache 142 first and written into database 210 at a later time. In yet another embodiment, a digital key 147 requiring frequent access may be simultaneously written to cache 142 and database 210 using write through caching 216.

Cache 142 may store a clustered database 218. System 110 may generate the clustered database 218 by categorizing the digital keys 147. The clustered database 218 may be include a plurality of categories with each storing a respective category of data, e.g., category 220, category 222, category 224, and category 226.

In one embodiment, a cloud container 146 may need to update its digital key 147, e.g., either because another cloud container 146 has issues, or user data 118 associated with the digital key 147 was updated, or the cloud container 146 is newly added to the cloud computing system 140. At operation 230, if there is a cache hit (i.e., the digital key 147 to be updated is stored in cache 142), the cloud container 146 may read from the digital key 147. At operation 232, if there is a cache miss (i.e., the digital key 147 to be updated is not stored in cache 142), the cloud container 146 may read the digital key 147 from the database 210. At operation 234, the cloud container 146 may further insert the digital key 147 to cache 142 when there is a cache miss.

Based on dynamic cache update 206, the cloud computing system 140 may generate secured distributed container blocks 236. As an example, and not by way of limitation, secured distributed container block 238 may store: address (e.g., n−1), last address, time stamp (e.g., t−1), and secured user data (represented by TAₓ₋₃ and TAₓ₋₂). Secured distributed container block 240 may store: address (e.g., n), last address, time stamp (e.g., t), and secured user data (represented by TAₓ₋₁ and TAₓ). TAₓ may correspond to updated user data.

### Creating a Dynamic Cache

FIG. 3 illustrates one embodiment of an operational flow 300 for creating a dynamic cache.

In one embodiment, user 125 may use user device 120 to transmit container identity data 302 to system 110. System 110 may generate hashed data 304 for the container identity data 302 using one or more hashing algorithms 119. System 110 may further embed a digital signature 115 into the hashed data 304 to generate a digital key 147. System 110 may then generate a signed request broadcast 308 for creating a dynamic cache 142 for the digital key 147.

In one embodiment, the signed request broadcast 308 may be received by a cloud computing system 140. System 110 may then perform cache identity block generation 310. During cache identity block generation 310, system 110 may perform a request verification test 312 by comparing the signed request with a collection of valid requests 314. If the signed request is a valid request 316, system 110 may create a cache block 318. System 110 may further perform cache block verification 320 to ensure that secured cache blocks are generated and can be securely used by devices and systems. In one embodiment, cache identity block generation 310 may comprise accessing a secured consensus protocol 322 (e.g., consensus algorithm 117) to determine a secured container 146 to store the digital key 147. As another example, the secured consensus protocol 322 may be based on proof of stake (PoS) or proof of work (PoW).

In one embodiment, system 110 may generate a plurality of secured cache blocks, e.g., cache block 326, cache block 328, cache block 330, cache block 332, cache block 334, cache block 336, and cache block 338. Each secured cache block may store a particular category of data. As illustrated in FIG. 3, cache block 338 may store request data 338a, hash of block 338b, time stamp 338c, and hash of previous block 338d.

### Example Methods for Using Dynamic Cache for Operating Cloud Containers

FIGS. 4A-4C illustrate an example flowchart of a method 400 for using dynamic cache for operating cloud containers. Modifications, additions, or omissions may be made to method 400. Method 400 may include more, fewer, or other operations. For example, operations may be performed in parallel or in any suitable order. While at times discussed as system 110, or components of any of thereof performing operations, any suitable system or components of the system may perform one or more operations of the method 400. For example, one or more operations of method 400 may be implemented, at least in part, in the form of software instructions (e.g., software instructions 116 of FIG. 1), stored on non-transitory, tangible, machine-readable media (e.g., memory 114 of FIG. 1) that when run by one or more processors (e.g., processors 112 of FIG. 1) may cause the one or more processors to perform operations 402-456.

After start, system 110 accesses a first set of user data 118 that requires frequent access in a distributed cloud computing system 140 at operation 402.

At operation 404, system 110 generates hashed data 304 of the first set of user data 118 by a hashing algorithm 119. System 110 may input the first set of user data 118 to the hashing algorithm 119, which then transforms the first set of user data 118 into a hash using a mathematical function.

At operation 406, system 110 generates a first digital key 147 by encrypting the hashed data 304 using a digital signature 115. The digital signature 115 may function as a private key embedded in the hashed data 304, which may be used for user authentication.

At operation 408, system 110 stores the first digital key 147 in a first container 146 executing on a first node 145 of the nodes 145 in the distributed cloud computing system 140. In an embodiment, system 110 may execute the consensus algorithm 117 to verify that the first container 146 is the most secured and valid container before storing the first digital key 147 in the first container 146. In an embodiment, system 110 may categorize the first set of the user data 118 into different categories, determine multiple portions of the first digital key 147 corresponding to the categories, and then store the portions of the first digital key 147 in different parts of the first container 146.

At operation 410, system 110 generates a request for a cache 142 in the distributed cloud computing system 140 to store the first digital key 147. System 110 may then broadcast the request to the cloud computing system 140.

At operation 412, system 110 determines whether the request is valid. In an embodiment, system 110 may determine whether the request is valid by comparing the request with a collection of valid requests 314. If the request is not valid, system 110 declines the request at operation 414. Method 400 then ends.

If the request is valid, system 110 generates the cache 142 using a distributed key-value store to store the first digital key 147 at operation 416. Generating the cache 142 may including creating multiple cache blocks 318. These cache blocks 318 may store different portions of the first digital key 147, corresponding to different categories of the first set of user data 118. System 110 may further perform cache block verification 320 to ensure that the cache blocks 318 can be securely used by devices and systems. Each node 145 in the distributed cloud computing system 140 can maintain a copy of the cache 142. In an embodiment, the first digital key 147 is accessible from the respective copy of the cache 142 associated with each node 145.

At operation 418, system 110 detects a trigger event associated with the first node 145. System 110 may detect the trigger event by analyzing different types of data associated with the first node 145. For example, the data may include utilization associated with the first node 145, network data associated with the first node 145, etc. In an embodiment, the trigger event includes one or more of a failure of the first node 145, a degraded performance of the first node 145, or a data transmission issue associated with the first node 145.

At operation 420, system 110 executes a consensus algorithm 117 on the nodes 145 of the distributed cloud computing system 140. At operation 422, system 110 selects a second container 146 executing on a second node 145 based on execution of the consensus algorithm. The execution may indicate the second container 146 is associated with a required data accuracy or a required security level. The consensus algorithm 117 may enable the nodes 145 to agree on a single state or decision by requiring a majority of nodes 145 to reach the same conclusion through a process of verifying and validating the containers 146. In operation 422, the nodes 145 agree on the second container 146 as the most secured and valid container 146.

At operation 424, system 110 retrieves the first digital key 147 from the copy of the cache 142 on the second node 145 and store the first digital key 147 in the second container 146. If there is a cache hit (i.e., the first digital key 147 is stored in the copy of the cache 142), the second container 146 may read from the first digital key 147. If there is a cache miss (i.e., the first digital key 147 is not stored in the copy of the cache 142), the second container 146 may read the first digital key 147 from a database 210 and further insert the first digital key 147 to the copy of the cache 142.

At operation 426, system 110 detects an update to the first set of user data 118. For example, the first set of user data 118 may be updated by a user 125 via a user device 120. As another example, the first set of user data 118 may be updated as a result of container operations. In an embodiment, digital key 147 may be configured to emit an event indicating the update of the first set of user data 118.

At operation 428, system 110 generates an updated first digital key 147 comprising the update to the first set of user data 118. System 110 may generate updated hashed data 304 of the updated first set of user data 118 by the hashing algorithm 119 and generate the updated first digital key 147 by encrypting the updated hashed data 304 using the digital signature 115.

At operation 430, system 110 stores the updated first digital key 147 in the second container 146. System 110 may categorize the updated first set of the user data 118 into different categories, determine multiple portions of the updated first digital key 147 corresponding to the categories, and then store the portions of the updated first digital key 147 in different parts of the second container 146.

At operation 432, system 110 updates the cache 142 to store the updated first digital key 147. Each node 145 in the distributed cloud computing system 140 can maintain a copy of the updated cache 142. In an embodiment, updating the cache 142 may include storing different portions of the updated first digital key 147 corresponding to different categories of the updated first set of user data 118 in different cache blocks 318.

At operation 434, system 110 detects a new container 146 added to the distributed cloud computing system 140. In an embodiment, system 110 may use one or more container monitoring tools to automatically detect new containers 146. The new container 146 may include a second digital key 147 corresponding to a second set of user data 118.

At operation 436, system 110 updates the cache 142 to store the second digital key 147. Each node 145 in the distributed cloud computing system 140 can maintain a copy of the updated cache 142. In an embodiment, updating the cache 142 may include storing different portions of the second digital key 147 corresponding to different categories of the second set of user data 118 in different cache blocks 318.

At operation 438, system 110 receives a request from a user device 120b via the distributed cloud computing system 140 to access a third set of user data 118. In an embodiment, system 110 may determine whether a user 125 associated with user device 120b is authorized to access the third set of user data 118. For example, the third set of user data 118 may belong to a certain category and only certain users 125 can access user data 118 belonging to that category. At operation 440, system 110 determines whether a third digital key 147 corresponding to the third set of user data 118 exist in the cache 142. If there is a cache hit, system 110 determines the third digital key 147 exists in the cache 142. If there is a cache miss, system 110 determines the third digital key 147 does not exist the cache 142. If the third digital key 147 does not exist, system 110 accesses the third set of user data 118 from a database 210 at operation 442.

At operation 444, system 110 generates hashed data 304 of the third set of user data 118. System 110 may input the third set of user data 118 to the hashing algorithm 119, which then transforms the third set of user data 118 into a hash using a mathematical function.

At operation 446, system 110 generates the third digital key 147 by encrypting the hashed data 304. In an embodiment, system 110 may generate the third digital key 147 by encrypting the hashed data 304 using the digital signature 115.

At operation 448, system 110 stores the third digital key 147 in the cache 142. In an embodiment, system 110 may store different portions of the third digital key 147 corresponding to different categories of the third set of user data 118 in different cache blocks 318 of the cache 142. Method 400 then proceeds to operation 450.

If the third digital key 147 exists at operation 440, method 400 proceeds to operation 450.

At operation 450, system 110 identifies a third node 145 having a minimal distance to the user device 120b among the nodes 145. For example, if user device 120b is in California, USA, a node 145 in USA instead of a node 145 in Europe may be identified as the third node 145.

At operation 452, system 110 retrieves the third digital key 147 from the copy of cache 142 on the third node 145.

At operation 454, system 110 decrypts the third digital key 147 to generate the third set of user data 118. System 110 may use the digital signature 115 that was used to encrypt the hashed data 304 corresponding to the third digital key to reverse the encryption process.

At operation 456, system 110 transmits the third set of user data 118 to the user device 120b via the third node 145.

Method 400 then ends.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory operable to store user data; and
a processor, operably coupled to the memory, and configured to:
access a first set of the user data from the memory;
generate, by a hashing algorithm, hashed data of the first set of the user data;
generate a first digital key by encrypting the hashed data using a digital signature;
store the first digital key in a first container operating on a first node of a plurality of nodes in a distributed cloud computing system;
generate a cache using a distributed key-value database to store the first digital key, wherein each of the plurality of nodes in the distributed cloud computing system maintains a copy of the cache, wherein the first digital key is accessible from a respective copy of the cache associated with each of the plurality of nodes;
detect a trigger event associated with the first node, the trigger event comprising one or more of a failure of the first node, a degraded performance of the first node, or a data transmission issue associated with the first node;
responsive to the detection of the trigger event, retrieve the first digital key from the copy of the cache associated with a second node of the plurality of nodes; and
store the first digital key in a second container executing on the second node.

2. The system of claim 1, wherein the processor is further configured to:
receive a request from a user device via the distributed cloud computing system to access the first set of the user data;
identify a third node having a minimal distance to the user device among the plurality of nodes;
retrieve the first digital key from the copy of cache on the third node;
decrypt the first digital key to generate the first set of the user data; and
transmit the first set of the user data to the user device via the third node.

3. The system of claim 1, wherein the processor is further configured to:
identify the first set of the user data based on determining that the first set of the user data requires access at a frequency higher than a threshold frequency.

4. The system of claim 1, wherein the processor is further configured to:
execute a consensus algorithm on the plurality of nodes; and
select the second container based on an execution result of the consensus algorithm, the execution result indicating the second container is associated with a required data accuracy or a required security level.

5. The system of claim 1, wherein the processor is further configured to:
detect a third container added to the distributed cloud computing system, wherein the third container comprises a second digital key corresponding to a second set of the user data; and
update the cache to store the second digital key, wherein each of the plurality of nodes in the distributed cloud computing system maintains a copy of the updated cache, wherein the second digital key is accessible from the respective copy of the updated cache associated with each of the plurality of nodes.

6. The system of claim 1, wherein the processor is further configured to:
detect an update to the first set of the user data;
generate an updated first digital key comprising the update to the first set of the user data;
store the updated first digital key in the second container; and
update the cache to store the updated first digital key, wherein each of the plurality of nodes in the distributed cloud computing system maintains a copy of the updated cache, wherein the updated first digital key is accessible from the respective copy of the updated cache associated with each of the plurality of nodes.

7. The system of claim 1, wherein the processor is further configured to:
categorize the first set of the user data into a plurality of categories;
determine a plurality of portions of the first digital key corresponding to the plurality of categories of the first set of the user data; and
store the plurality of portions of the first digital key in a plurality of parts of the first container.

8. The system of claim 7, wherein the processor is further configured to:
generate a plurality of blocks in the cache to store the plurality of portions of the first digital key, respectively.

9. The system of claim 1, wherein the processor is further configured to:
receive a request from a user device to access a second set of the user data;
determine a second digital key corresponding to the second set of the user data does not exist in the cache;
access the second set of the user data from the memory;
generate, by the hashing algorithm, hashed data of the second set of the user data;
generate the second digital key by encrypting the hashed data using the digital signature;
store the second digital key in the cache;
identity a third node having a minimal distance to the user device among the plurality of nodes;
retrieve the second digital key from the copy of cache on the third node;
decrypt the second digital key to generate the second set of the user data; and
transmit the second set of the user data to the user device via the third node.

10. The system of claim 1, wherein the processor is further configured to:
generate a request for the cache based on the first digital key;
determine the request is a valid request by comparing the request with a collection of valid request; and
generate the cache responsive to determining the request is a valid request.

11. A method comprising, by one or more computing systems:
accessing a first set of user data;
generating, by a hashing algorithm, hashed data of the first set of the user data;
generating a first digital key by encrypting the hashed data using a digital signature;
storing the first digital key in a first container operating on a first node of a plurality of nodes in a distributed cloud computing system;
generating a cache using a distributed key-value database to store the first digital key, wherein each of the plurality of nodes in the distributed cloud computing system maintains a copy of the cache, wherein the first digital key is accessible from a respective copy of the cache associated with each of the plurality of nodes;
detecting a trigger event associated with the first node, the trigger event comprising one or more of a failure of the first node, a degraded performance of the first node, or a data transmission issue associated with the first node;
responsive to the detection of the trigger event, retrieving the first digital key from the copy of the cache associated with a second node of the plurality of nodes; and
storing the first digital key in a second container executing on the second node.

12. The method of claim 11, further comprising:
receiving a request from a user device via the distributed cloud computing system to access the first set of the user data;
identifying a third node having a minimal distance to the user device among the plurality of nodes;
retrieving the first digital key from the copy of cache on the third node;
decrypting the first digital key to generate the first set of the user data; and
transmitting the first set of the user data to the user device via the third node.

13. The method of claim 11, further comprising:
executing a consensus algorithm on the plurality of nodes; and
selecting the second container based on an execution result of the consensus algorithm, the execution result indicating the second container is associated with a required data accuracy or a required security level.

14. The method of claim 11, further comprising:
detecting a third container added to the distributed cloud computing system, wherein the third container comprises a second digital key corresponding to a second set of the user data; and
updating the cache to store the second digital key, wherein each of the plurality of nodes in the distributed cloud computing system maintains a copy of the updated cache, wherein the second digital key is accessible from the respective copy of the updated cache associated with each of the plurality of nodes.

15. The method of claim 11, further comprising:
detecting an update to the first set of the user data;
generating an updated first digital key comprising the update to the first set of the user data;
storing the updated first digital key in the second container; and
updating the cache to store the updated first digital key, wherein each of the plurality of nodes in the distributed cloud computing system maintains a copy of the updated cache, wherein the updated first digital key is accessible from the respective copy of the updated cache associated with each of the plurality of nodes.

16. A non-transitory computer-readable medium storing instructions that when executed by a processor cause the processor to:
access a first set of user data;
generate, by a hashing algorithm, hashed data of the first set of the user data;
generate a first digital key by encrypting the hashed data using a digital signature;
store the first digital key in a first container operating on a first node of a plurality of nodes in a distributed cloud computing system;
generate a cache using a distributed key-value database to store the first digital key, wherein each of the plurality of nodes in the distributed cloud computing system maintains a copy of the cache, wherein the first digital key is accessible from a respective copy of the cache associated with each of the plurality of nodes;
detect a trigger event associated with the first node, the trigger event comprising one or more of a failure of the first node, a degraded performance of the first node, or a data transmission issue associated with the first node;
responsive to the detection of the trigger event, retrieve the first digital key from the copy of the cache associated with a second node of the plurality of nodes; and
store the first digital key in a second container executing on the second node.

17. The non-transitory computer-readable medium of claim 16, wherein the instructions further cause the processor to:
receive a request from a user device via the distributed cloud computing system to access the first set of the user data;
identify a third node having a minimal distance to the user device among the plurality of nodes;
retrieve the first digital key from the copy of cache on the third node;
decrypt the first digital key to generate the first set of the user data; and
transmit the first set of the user data to the user device via the third node.

18. The non-transitory computer-readable medium of claim 16, wherein the instructions further cause the processor to:
execute a consensus algorithm on the plurality of nodes; and
select the second container based on an execution result of the consensus algorithm, the execution result indicating the second container is associated with a required data accuracy or a required security level.

19. The non-transitory computer-readable medium of claim 16, wherein the instructions further cause the processor to:
detect a third container added to the distributed cloud computing system, wherein the third container comprises a second digital key corresponding to a second set of the user data; and
update the cache to store the second digital key, wherein each of the plurality of nodes in the distributed cloud computing system maintains a copy of the updated cache, wherein the second digital key is accessible from the respective copy of the updated cache associated with each of the plurality of nodes.

20. The non-transitory computer-readable medium of claim 16, wherein the instructions further cause the processor to:
detect an update to the first set of the user data;
generate an updated first digital key comprising the update to the first set of the user data;
store the updated first digital key in the second container; and
update the cache to store the updated first digital key, wherein each of the plurality of nodes in the distributed cloud computing system maintains a copy of the updated cache, wherein the updated first digital key is accessible from the respective copy of the updated cache associated with each of the plurality of nodes.
